(19) United States
(12) Patent Application Publication
(10) Pub. No.: US 2009/0056352 A1
(43) Pub. Date: Mar. 5, 2009

(54) Multi air conditioner system and auto changeover method for multi air conditioner system

(76) Inventors: Min Gi Kim, Seoul (KR); Chan Ho Song, Seoul (KR); Jae Hoon Sim, Seoul (KR)

Correspondence Address: MCKENNA LONG & ALDRIDGE LLP, 1900 K STREET, NW, WASHINGTON, DC, 20006, US

(21) Appl. No.: 12/222,454

(22) Filed: Aug. 8, 2008

(30) Foreign Application Priority Data
Sep. 3, 2007 (KR) 10-2007-0089062

(51) Int. Cl. F25B 7/00; F25D 23/12; G05B 15/00

(52) U.S. Cl. 62/175; 62/259.1; 700/277

(57) ABSTRACT

A multi air conditioner system in one example performs a cooling and heating changeover by selectively granting priority to one or more indoor units, determining whether there is one or more operating indoor units with priorities, and granting a control right for auto changeover to at least one indoor unit with priority.

### BACKGROUND

1. Technical Field

The present disclosure relates to a multi air conditioner system and an auto changeover method using the same, and more specifically to a selective grant of control right for auto changeover to a plurality of outdoor units connected to at least one indoor unit.

2. Background

An air conditioner is an apparatus for maintaining indoor air at a certain temperature. In the past, an indoor unit and an outdoor unit constituting the air conditioner were in a one-to-one correspondence relationship. A multi air conditioner constituted by a plurality of indoor units connected to one outdoor unit subsequently appeared due to developments of the air conditioner.

The air conditioner may have an auto changeover function, that is, a function of automatically changing over to a cooling and heating operation mode to reach a user desired temperature. The auto changeover is particularly suitable for climate with a wide variation in the daily temperature. For example, if a user wants a temperature of 18° C. in a climate showing a temperature difference of 25° C. during the day and 12° C. during the night, the auto changeover is suitable where performing the cooling operation during the day and the heating operation during the night is required.

FIG. 1 shows a process of performing an auto changeover.

First, a user desired temperature is selectively set (S510). Thereafter, an indoor temperature is detected (S520).

If the indoor temperature is lower than a temperature set by a user, that is, below a certain value when compared to the set temperature (S530), the operation mode is changed over to the heating operation mode (S540). If the indoor temperature is above a certain value when compared to the set temperature (S550), the operation mode is changed over to the cooling operation mode (S560). And if the indoor temperature does not correspond to both cases as described above, the previous operation mode (S570) is maintained.

The above operations are repeated until the auto changeover stop request (S580) is issued.

Meanwhile, the certain value used when comparing the indoor temperature with the set temperature is 2 in FIG. 1, that is, 2° C. However, this value can be changed as needed.

The auto changeover method as described above is a method applied to a single air conditioner constituted by the outdoor unit and the indoor unit that are in a one-to-one correspondence relationship and provides the user the desired day and night temperature.

### SUMMARY

In the current multi air conditioner, the outdoor unit takes the cooling or heating operation mode of the first operated indoor unit when initially driving the air conditioner. At this time, the taken operation mode cannot be changed until all the operating indoor units are turned-off.

Therefore, when the current multi air conditioner needs to changeover the operation mode, all indoor units are turned off and then operated again so as to changeover the operation mode of the first operating indoor unit to a desired mode.

Thus, the above method cannot perform the automatic cooling and heating changeover and this causes great inconvenience in using the multi air conditioner.

Accordingly, the disclosure describes a way to perform auto changeover in a multi air conditioner where a plurality of indoor units are connected to one outdoor unit and the outdoor unit can be operated in only one operation mode at a given time.

Therefore, a user may perform cooling and heating changeover (auto changeover) function of a single air conditioner in the multi air conditioner.

For instance, a priority granting unit grants priority to one or more indoor units, and an auto changeover unit determines whether the one or more indoor units granted with priorities are operating and granting control right for auto changeover to at least one operating indoor unit with priority.

The auto changeover unit may grant the control right for the auto changeover only to the indoor unit with highest priority among the indoor units with priorities.

Also, in the case where the indoor unit granted with control right (control indoor unit) is turned-off and there are no other operating indoor units with priorities, the auto changeover unit maintains an operation mode of the control indoor unit that was turned-off. Herein, when all the operating indoor units request the same auto changeover, the auto changeover unit may perform the auto changeover in response to the request.

The auto changeover unit may grant the control right for the auto changeover to the first operating indoor unit (the beginning operated indoor unit).

The auto changeover unit may maintain the operation mode in the beginning operation of the beginning operating indoor unit in the case where the beginning operating indoor unit is not the indoor unit with priority. In this case, the auto changeover unit may not change the control right for the auto changeover even though subsequently indoor units with priorities are operating, after the beginning operating indoor unit operates. Also, in the case where all the operating indoor units request the same auto changeover, the auto changeover unit may perform the auto changeover in response to the request.

Meanwhile, the priority granting unit may comprise: a priority input judging unit judging whether it is in a priority input mode; and in the case where the priority input mode is selected in the priority input judging unit, a priority selecting unit selectively granting the priority to the indoor unit by the input of a user.

An auto changeover method comprises the steps of: selectively granting priority to one or more indoor units among a plurality of indoor units; determining whether there is one or more indoor units with priorities among the operating indoor units; and granting control right for auto changeover to at least one indoor unit with priority.

The step of granting the control right preferably grants the control right for the auto changeover to the indoor unit with highest priority among the indoor units with priorities.

Meanwhile, the method may further comprise granting control right for auto changeover to a first operating indoor unit, wherein the first operating indoor unit is not granted with priority.

Further, the step of changing over the operation may maintain an operation mode of the indoor unit granted with control right when the indoor unit granted with control right is turned-off and there are no other operating indoor units with priorities Further, when all the operating indoor units request the same auto changeover, the step of changing over the operation may perform the auto changeover in response to the request.

### BRIEF DESCRIPTION OF THE DRAWINGS

FIG. 1 is a flow chart showing a process of performing auto changeover.

FIG. 2 is a block diagram showing a multi air conditioner according to one embodiment of the present invention.

FIG. 3 is a block diagram showing a multi air conditioner according to another embodiment of the present invention.

FIG. 4 is a flow chart showing one exemplary operation of the multi air conditioner of FIG. 2.

FIG. 5 is a flow chart showing another exemplary operation of the multi air conditioner of FIG. 2.

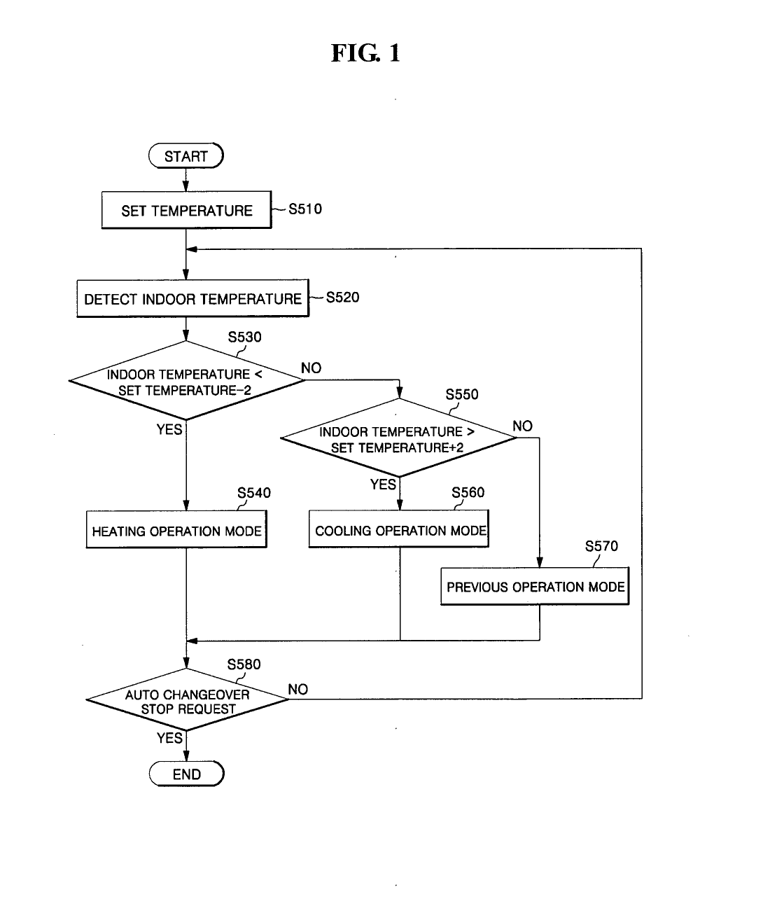

### DESCRIPTION OF THE EMBODIMENTS

Hereinafter, one embodiment of the present invention will be described in detail with reference to the accompanying drawings.

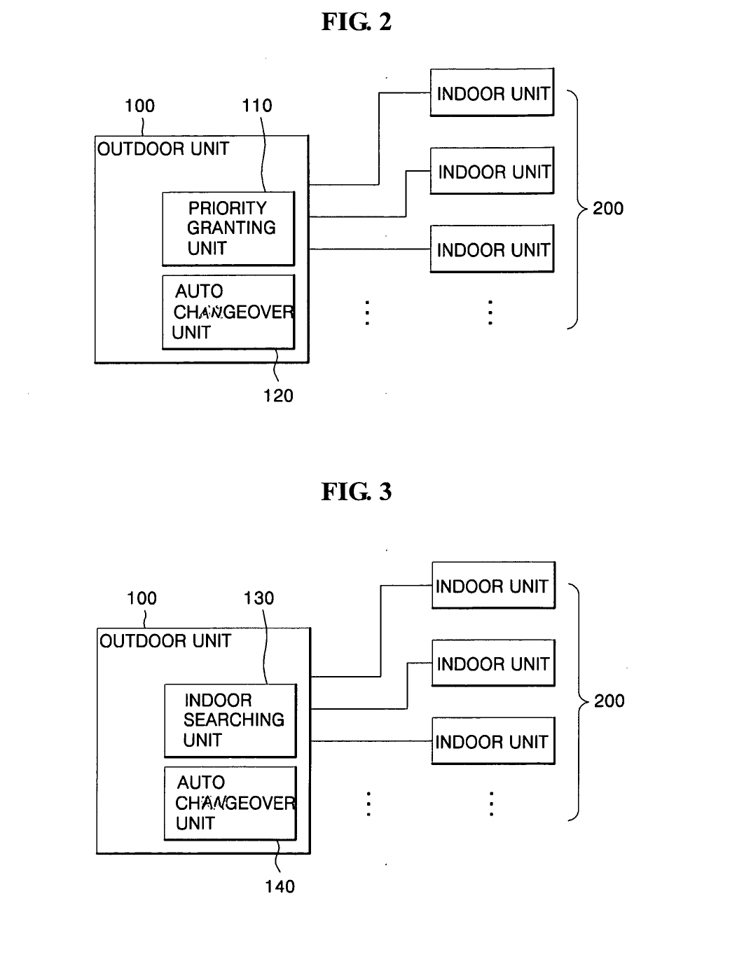

FIG. 2 is a schematic diagram showing a multi air conditioner according to one embodiment of the present invention.

Referring to FIG. 2, a multi air conditioner comprises a priority granting unit 110 that grants priority to one or more indoor units among a plurality of indoor units 200 connected to an outdoor unit 100; and an auto changeover unit 120 that determines whether the indoor units granted with priorities (indoor units with priorities) are operating and granting control right for auto changeover to the operating indoor units with priorities.

The priority granting unit 110 is a component that selectively grants the priority to one or more indoor units among the plurality of indoor units 200. The priority granting unit 110 may be disposed at the indoor unit or the outdoor unit and may be constituted by a dip switch or a switch of a circuit included in an outside operating unit.

All indoor units may have priorities or it may be only one indoor unit. This may be determined by user selection.

The auto changeover unit 120 changes over a cooling or heating operation mode of the outdoor unit 100. When there is the indoor unit granted with control right (control indoor unit), the changeover is performed through the control indoor unit.

Therefore, even when the indoor unit with priority is operated after other indoor units (including the previously operating indoor unit with priority) are operating, the control right for the auto changeover is granted to the newly operating indoor unit with priority.

Consequently, the multi air conditioner may perform the auto changeover using the control indoor unit.

Meanwhile, the object of the control indoor unit is control operation of indoor units and there may be a plurality of control indoor units.

When there is the plurality of control indoor units, one or more control methods for the auto changeover may be performed so as to prevent system errors due to the plurality of controls.

For example, there may be a method of performing the auto changeover by means of the latest control.

However, when there is a plurality of control indoor units as above, it can be expected that the operation mode of the outdoor unit may be frequently changed over. Such a frequent changeover may impose a heavy burden on the overall system of the air conditioner. That is, it may cause a problem to the stability of the system.

Therefore, even though there is a plurality of operating indoor units with priorities, there is a need to limit the grant of control right to some degree, as needed.

Specifically, even though the plurality of indoor units with priorities is operating, the control right for the auto changeover is granted only to one of the indoor units with priorities so that there may be only one control indoor unit at a given time. Hereinafter, the contents thereon will be described.

First, the auto changeover unit 120 may grant the control right for the auto changeover only to indoor unit with highest priority among the determined indoor units with priorities.

To this end, the priority granting unit 110 is needed to grant differentiated priority to the indoor units with priorities.

For instance, the priority granting unit 110 grants the differentiated priority to one or more indoor unit and the auto changeover unit 120 determines whether there is an indoor unit granted with priority among the operating indoor units. In the case where more than one indoor unit granted with priority are operating, the control right for the auto changeover is granted to the indoor unit with highest priority by comparing the priorities among operating indoor units.

If the indoor unit with higher priority than the current control indoor unit is operated later, the control right for the auto changeover is handed over to the indoor unit with the higher priority.

Also, when the indoor unit to which the control right for the auto changeover is granted is turned-off, the control right may be handed over to the indoor unit with next highest priority among the operating indoor units.

With this, since there is only one indoor unit with control right at a given time, the auto changeover is performed through one control indoor unit. At this time, the indoor unit, which conforms to the operation mode of the control indoor unit, operates, and the indoor unit, which does not conform to the operation mode thereof, maintains a standby mode. Of course, the latter can perform a ventilating operation, as needed.

The auto changeover unit 120 preferably maintains the cooling or heating operation mode of the control indoor unit when the control indoor unit is turned-off and there are no other indoor units with priorities to assume the auto changeover.

This limits the auto changeover to prevent the frequent changeover, since the auto changeover itself is an operation imposing a heavy burden on the air conditioner system itself. In this case, when other priorities granted indoor units are operating after the control indoor unit is turned-off, the control right for the auto changeover may be granted to the indoor unit with highest priority by comparing the priorities among the operating indoor units or the operation mode of the control indoor unit may be maintained after the control indoor unit is turned-off, that is, the control right may not be granted to all indoor units.

Meanwhile, several situations may be inferred in view of the above-mentioned embodiment.

The situations include a case where the indoor unit granted with priority is operating at the initial operation of the air conditioner and a case where the indoor unit granted with priority is not operating at the initial operation of the air conditioner. The former case handles the control right for the auto changeover as described above.

The former case may be based on the premise that at least one indoor unit with priority is operating at the beginning operation of the air conditioner and the control right for the auto changeover may be granted to the indoor unit with priority by comparing the priorities of the operating indoor units with priorities, irrespective of whether the indoor unit with priority is operating at the beginning operation of the air conditioner.

The latter case may maintain the selected operation mode of the indoor unit beginning to operate when all indoor units are turned-off and the control right for the auto changeover may be granted to the indoor unit beginning to operate. In other words, if the control right is granted to the first indoor unit that operates at the beginning operation of the air conditioner and the cooling or heating operation mode is selected. The control right remains with the first indoor unit that began to operate and is not transferred to the other indoor units that subsequently begins to operate.

The method that makes only one indoor unit the control indoor unit at a given time by granting the control right for the auto changeover to the indoor unit with highest priority among the operating indoor units with priorities has been described above.

Also, a method having only one control indoor unit at a given time by granting the priority only to one indoor unit may be considered.

In this case, the grant of the priority means the grant of the control right for the auto changeover. The method above makes clear which indoor unit has the control right for the auto changeover, thereby solving the inconvenience of the user keeping track of which indoor unit has the priority. Also, a separate priority comparison algorithm is not required and the user knows which indoor unit to control in order to perform the auto changeover, which is generally one.

Meanwhile, although the auto changeover unit 120 is described in the example as granting the control right to the indoor unit with highest priority, there is a need to perform the process for the auto changeover when all the indoor units granted with priorities are not operating.

First, the auto changeover unit 120 may perform the auto changeover according to the control of an operating indoor unit at the beginning operation of the air conditioner where all the indoor units with priorities are not operating. Consequently, this means that the control right for the auto changeover has been granted.

Subsequently, if the control indoor unit is turned-off, the cooling or heating operation mode is preferably maintained at the turned-off point in time. Thereafter, if the indoor unit granted with priority is operated, the control right may be granted to the indoor unit with priority or the control right may not be granted at all including the indoor unit with priority.

Although the existing initially operating indoor unit is turned-off and then operated again, the control right may not be granted again. The reason is that when the existing initially operated indoor unit is re-operated, and if the control right is again granted thereto, the user may be confused as to which indoor unit has the control right.

Next, the auto changeover unit 120 may maintain the operation mode of the first operated indoor unit during initial operation when all the indoor units with priorities are not operating.

Further, although the indoor unit with priority is operated after the first operated indoor unit is operating, the auto changeover unit 120 may not grant the control right to the indoor unit with priority.

In this case, the auto changeover unit 120 maintains the operation mode of the first operated indoor unit until all the operating indoor units are turned off.

This means that the operation mode selected at the indoor unit operating in the beginning is maintained despite any operation so that the frequent auto changeover is prevented to thereby secure stability of the air conditioner.

In the methods of maintaining the operation mode at the time of the control indoor unit being turned off, when all the operating indoor units request the same auto changeover that is different from the operation mode to be maintained, the auto changeover unit 120 performs the auto changeover corresponding to the request, thereby preferably contributing to the convenience of the user.

Meanwhile, the position where the priority granting unit 110 and the auto changeover unit 120 are located is preferably at the outdoor unit. In a multi air conditioner, there is usually only one outdoor unit. The outdoor unit is usually connected to all the indoor units, and the priority granting unit 110 granting the priority to each indoor unit is preferably located at the outdoor unit. Since the auto changeover is performed in the outdoor unit, the auto changeover unit is preferably located at the outdoor unit.

Of course, since the transmission and reception of data between the respective indoor units may be made via wiring, the priority granting unit 120 may be located at the indoor unit, but the indoor unit is usually not provided with the priority granting unit, that is, the existing indoor unit is difficult to use as it is.

However, since most of the priority granting units are controlled by the user, they are preferably located at the indoor unit generally accessible and operated by the user. The location of the priority granting units will usually be determined by user needs or the manufacturer's intentions.

The auto changeover may be formed at the indoor unit. There may be a case where an indoor unit exclusively for the auto changeover is needed. That is, the indoor unit should comprises components required for the auto changeover such as a component searching whether there is an indoor unit operating, but the four-way valve to perform the changeover is disposed at the outdoor unit.

Meanwhile, when both the priority granting unit 110 and the auto changeover unit 120 are not operating or only the auto changeover unit 120 is not operating, it is preferable to maintain the first selected operation mode of the multi air conditioner until all the indoor units are turned-off.

When the auto changeover unit 120 is not operating, the first selected operation mode is the operation mode selected in the first operated indoor unit when the air conditioner begins to operate. As described above, when all the operating indoor units request the same operation mode, it is preferable to contribute to the convenience of the user by performing the auto changeover to the requested operation mode.

For reference, when the indoor unit other than the control indoor unit, that is, the indoor unit not granted with the control right does not conform to the operation mode of the control indoor unit, it is placed under standby mode (idle mode), and the indoor unit conforming to the operation mode of the control indoor unit operates in the same operation mode as the operation mode of the control indoor unit.

More specifically, in reviewing the priority granting unit 110, it may comprise a priority input judging unit judging whether a priority determination mode is selected by the user; and in the case where the priority determination mode is selected in the priority input judging unit, a priority selecting mode unit selectively grants the priority to the indoor unit based on the input of the user.

The priority input judging unit is a component judging whether the user is requesting the setting or changing of the priority. Preferably, the unit requests operations other than the operations of the general indoor unit or outdoor unit by means of the user.

Priority may be inputted in the same method as inputting the operation method of the indoor unit or outdoor unit and thus, the priority may be granted to the wrong indoor unit. Therefore, the input judging unit preferably judges the priority determination mode through an arrangement of keys differentiated from other keys, pressing of priority operating keys beyond a certain time, or using an encryption input method.

The keys differentiated from other operating keys may be done through special keys such as keys covered with a cover so as to not to be operated thereto during ordinary operation. The press of the priority operating keys beyond a certain time means that the priority operating keys are not allowed to enter the priority selection mode if they are not pressed for a certain time period of time, although the priority operating keys select the priority selection mode. The encryption input method means a method that allows the priority operating keys to enter the priority selection mode by means of a combination of certain keys and a pressed order.

The three methods may be used individually. Also, a combination of two or three methods may be used. This should be decided in view of the protection of the air conditioner system and convenience for user intending to enter the priority selection mode.

Specifically, the priority granting unit may be formed using a dip switch or may be located at a remote controller. Preferably, the dip switch is covered with a cover so as not to be inadvertently touched. Preferably, to grant priority, the remote controller has to be pressed beyond a certain time, the encryption input method may be used, or a combination thereof.

FIG. 3 is a schematic block diagram showing a multi air conditioner according to another preferred embodiment of the present invention. The multi air conditioner comprises: an indoor unit searching unit 130 searching whether each indoor unit 200 is operated; and an auto changeover unit 140 performing an auto changeover according to the control of the indoor unit that has been determined as the first operating indoor unit.

The indoor unit searching unit 130 is a component that searches and determines whether one or more indoor units 200 connected to the one outdoor unit 100 are operating. The unit 130 locates the first operating indoor unit so that the auto changeover unit 140 recognizes the first operating indoor unit.

The auto changeover unit 140 is a component that grants the control right for the auto changeover to the first operating indoor unit located by the indoor unit searching unit 130. The unit 140 performs the auto changeover according to the control of the indoor unit to which the control right is granted.

When the control indoor unit is turned-off, it is preferred that the auto changeover unit 140 maintains its cooling or heating operation mode at the time the control indoor unit is turned off. This means that the control right is not granted to all other operating indoor units. Also, even though the control indoor unit is turned-off and then operated again, the control right is not again granted to the control indoor unit and the operation mode at that time the control indoor unit first turned-off is maintained as it is.

This is to prevent the frequent auto changeover as described above. This is advantageous in view of the protection of the air conditioner system, but when the user wants to changeover the operation mode later, the user has to turn off all the indoor units and then operate them again, which causes inconvenience to the user.

Therefore, when all the operating indoor units request the same auto changeover, it is preferable that the auto changeover unit 140 performs the auto changeover corresponding to the request.

Of course, in this instance, there is no operating control indoor unit and the request to change over is performed when the last operating indoor unit requests a change over.

Reviewing the operation of the indoor unit other than the control indoor unit, the indoor unit, which does not conform to the operation mode of the control indoor unit being the indoor unit controlling the auto changeover, is changed over to a standby mode. The indoor unit, which conforms to the operation mode of the control indoor unit, is operated in the same operation mode as the operation mode of the control indoor unit.

Rearranging the aforementioned contents, the priority may be granted to one or more indoor units, and the control right for the auto changeover may be granted to the indoor unit with highest priority among the operating indoor units to perform the auto changeover. Other indoor units are then operated in the operation mode or standby mode according to whether they conform or do not conform with the operation mode of the control indoor unit.

Since this method may grant the priority to the user desired indoor unit, it prevents the unwanted auto changeover from being performed by not granting the priority to the indoor unit in instances where the users without a general knowledge of the auto changeover, that is, users such as children, old people, or temporary visitors, and prevents the frequent auto changeover to protect the system.

The case granting the control right for the auto changeover to the first operating indoor unit does not require the process such as granting a separate priority, thereby contributing to the convenience of use. However, where the users without a general knowledge have access to the auto changeover, frequent auto changeover may be performed. In this case, it is disadvantageous in view of protecting the system.

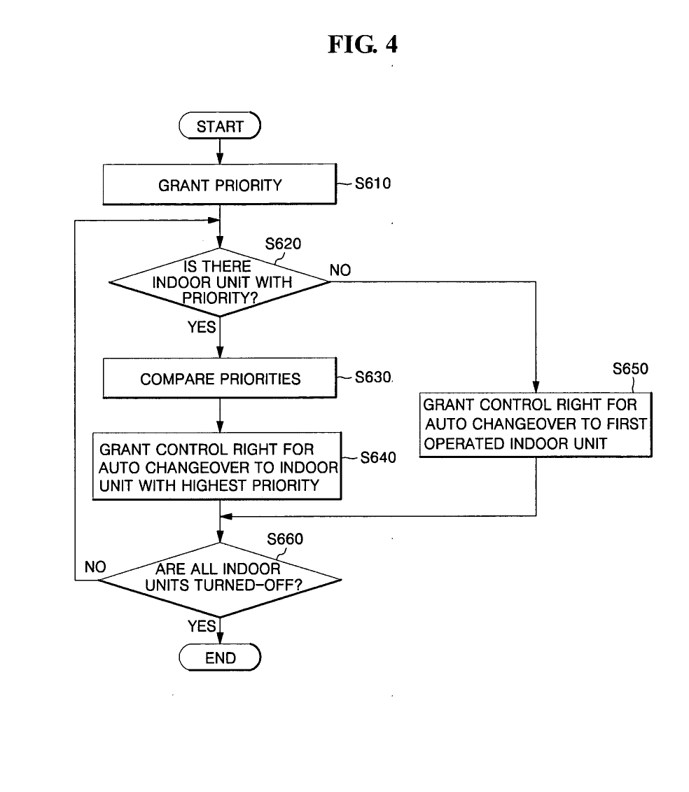

The operation of the multi air conditioner according to an embodiment of the present invention as described above will be described with reference to FIG. 4. First, the priority is selectively granted to one or more indoor units of the plurality of indoor units (S610). The grant of the priority is performed by the priority granting unit 110 and the priority may be granted to the plurality of indoor units or to only one indoor unit. Preferably, the grant of the priority is performed by the user. To this end, the priority granting unit may comprise: the priority input judging unit judging whether the priority determination mode for setting the priority is selected; and the priority selecting mode unit granting the priority to the indoor unit based on the input of the user.

After the priority is granted to the predetermined indoor unit, it searches whether there is another indoor unit granted with the priority among the operating indoor units (S620).

This allows consideration of several situations. The situations may include a situation searching whether there is the indoor unit with priority among the first operating indoor units (there may be several first operating units) and a situation searching whether the indoor unit with priority is operating irrespective of time.

The former case is a situation granting a double locking system for the auto changeover. That is, the former case can be applied only when the following two cases should be satisfied in order to grant the control right for the auto changeover to the predetermined indoor unit: 1) the indoor unit should be the beginning operating indoor unit, and 2) the indoor unit should be granted with the priority. In the case where the indoor unit granted with the priority is operating at the point in time other than the point in time when an indoor unit first operates, the control right is excluded from the indoor unit granted with priority.

The latter case may be applied if the priority is granted.

FIG. 4 shows the process of repetitively searching whether there is the indoor unit with priority. This shows the latter case.

Although the indoor unit with higher priority is later operated than the indoor unit with lower priority, this case hands over the control right for the auto changeover to the indoor unit with higher priority.

The latter case is more flexible in view of the change of the control right as compared to the former case, but the frequent change of the control right can confuse the user.

After searching whether there is an indoor unit with priority, if the search reveals that there are a plurality of indoor units with priorities, the priorities among the indoor units with priorities are compared (S630). According to the comparison result, the control right for the auto changeover is granted to the indoor unit with highest priority (S640) and the auto changeover is performed by means of the control of the control indoor unit.

The differentiated priorities are granted to the indoor units with priorities and the same priority may be granted to more than one indoor unit in some cases.

In the case where the same priority is granted to a plurality of indoor units, if the same priority is the highest priority, the control right for the auto changeover may be granted to all the indoor units granted with the same priority.

In the case where the control right for the auto changeover is granted to the plurality of indoor units, that is, the control indoor unit is plural, and thus it is disadvantageous in view of the protection of the air conditioner system. Therefore, it is preferable that the number of the control indoor units is limited separately.

For example, when the plurality of control indoor units makes different requests, it is preferable that the air conditioner system does not operate in response to each request, but maintains its current operation mode or is operated in response to the latest input request.

Also, the priority as a so-called limitation condition excluding the grant of the control right for the auto changeover to the indoor unit with priority may be used in some cases. That is, a predetermined priority is granted to the indoor unit which may not want to have the control right for the auto changeover in all cases. Thus the priority does not have a function of granting the control right, making it possible to prevent the control right from granting to the predetermined indoor unit. In this case, the priority performs a role as a kind of locking system.

Meanwhile, in the step of searching whether there is the indoor unit with priority, when the indoor unit with priority is not operated, the control right for the auto changeover may be granted to the first operating indoor unit (S650).

This case is more flexible in view of the changeover of the control right, while since the users other than the user operating the beginning indoor unit do not recognize which indoor unit has the control right for the auto changeover. It is preferable that each indoor unit comprises a displaying unit identifying which unit has the control right.

Of course, in each indoor unit, the display of the identifier of the control indoor unit can be applied to all the other examples described above. Also, it is preferable that the identifier displaying unit is included in the outdoor unit. It is advantageous that the identifier displaying unit used in each indoor unit is used in the outdoor unit.

When the indoor unit with higher priority is operated later, the control right for the auto changeover may be granted to the indoor unit with higher priority.

However, since this case can confuse the user due to the change of the control indoor unit, although the indoor unit with higher priority than the control indoor unit is operated later, the control right can be maintained by the previously granted indoor unit.

Preferably, the mode selection is performed on a predetermined menu by the user or by the operation of buttons.

When the control indoor unit is turned-off in the above process, the operation mode at the turned-off point in time may be maintained until all the indoor units are turned-off. It is advantageous in view of the protection of the system, but when the user requests the changeover, the user has to turn off all the indoor units causing inconvenience. Therefore, the control right may be granted to the operating indoor unit with highest priority at the time when the control indoor unit is turned-off or when all the operating indoor units make the same request; it is preferable that only the changeover corresponding to the request is performed.

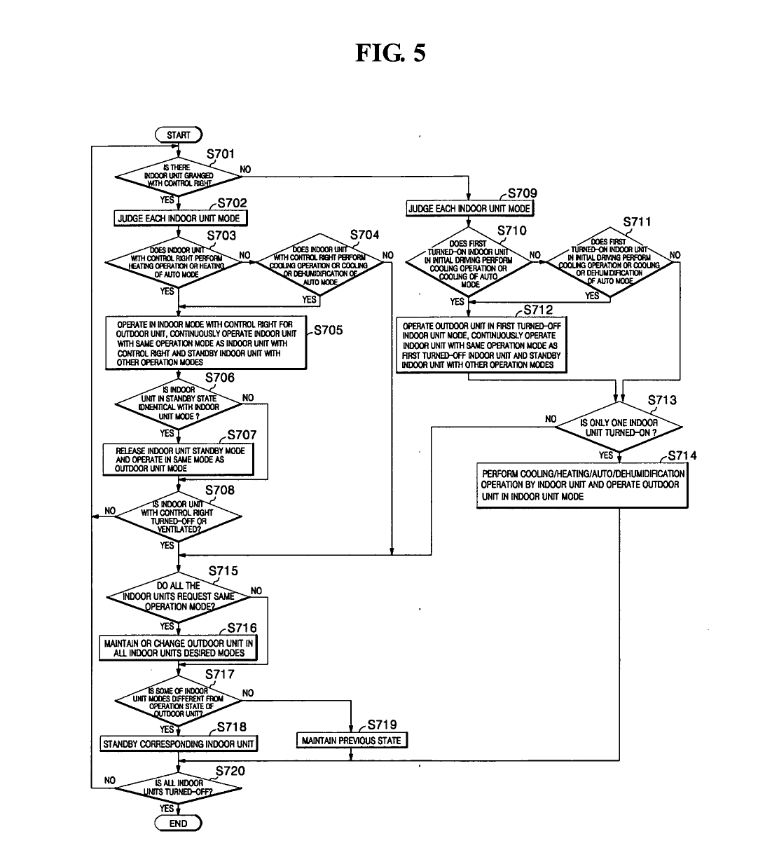

FIG. 5 is a flow chart showing an operating method of the multi air conditioner according to another embodiment of the present invention.

FIG. 5 shows a step of judging whether there is the control indoor unit granted with the control right for the auto changeover, under the assumption that the step of granting the control right for the auto changeover according to the comparison of priorities or the step of granting the control right for the auto changeover to the first operated indoor unit has been previously performed.

First, it judges whether there is a control indoor unit (S701). When there is a control indoor unit, the operation mode of each indoor unit is judged (S 702).

It searches whether the control indoor unit performs the heating operation/the heating operation of the auto mode (S703) and the cooling operation/the cooling operation of the auto mode (S704). When the control indoor unit is operated in a predetermined operation mode, the indoor unit other than the control indoor unit performs the operation when its operation mode is the same as the operation mode of the control indoor unit by the comparison of its operation mode with the judged operation mode. Otherwise, the indoor unit maintains the standby mode (S705). If the indoor unit of the standby mode conforms to the operation mode of the control indoor unit (S706), it performs the operation (S707).

For reference, the auto mode defines a mode in a process of automatically changing over from the cooling operation to the heating operation, and vice versa.

If the control indoor unit is turned-off or performs only ventilation, the auto changeover by means of the control indoor unit is not performed (S708). Accordingly, when all the indoor units other than the control indoor unit request the same operation mode (S715), this case changes over the operation mode according to the request for the convenience of the user (S716).

The operation mode is changed over by the requests of all the indoor units. When some of the indoor units make different requests from the changed over operation mode (S717), the changeover is not performed so that the indoor unit requesting other operation modes is the standby mode (S718) and the indoor unit conforming to the changed over operation mode maintains its operation mode (S719).

Referring again to FIG. 5, when there is no control indoor unit, the process of judging the modes of each indoor unit is equally performed as described above (S709) and the operation is performed according to the operation mode of the first operating indoor unit. That is, if the heating operation/the heating of the auto mode (S710) and the cooling operation/the cooling of the auto mode selected in the first operating indoor unit (S711) are defined, the change thereof is usually not permitted.

Herein, the auto mode may be the cooling or the heating in the case where the changeover of the cooling and the heating is performed, thus when the first indoor unit is operating, this case is substantially operating in the general cooling operation mode and heating operation mode. That is, the air conditioner for cooling and the air conditioner for heating are operated together, wherein they cannot be changed over to each other.

The indoor units other than the first operating indoor unit perform the operations when they conform to the mode selected in the first operating indoor unit or otherwise, maintain the standby mode.

In the case where only one indoor unit is operating (S713), it is preferable that the auto changeover is performed by the indoor unit without considering the priority or the turned-on order.

In the case where only one indoor unit is operating, one should consider whether the priority should be granted as described above. However, in the case where the plurality of indoor units are operating and then, the rest of the indoor units are turned-off and only one indoor unit is operating, this is applied to all the examples as described above. This case may be interpreted as a case corresponding to the case where all the remaining indoor units make the same request as described above (S715).

As an example, an outdoor unit connected to a plurality of indoor units is applied to a multi air conditioner which may be capable of performing only one operation mode of cooling or heating at a given time.

This application claims the benefit of Korean Patent Application No. 10-2007-0089062 filed on Sep. 3, 2007, which is hereby incorporated by reference for all purposes as if fully set forth herein.

What is claimed is:

1. A multi air conditioner comprising:
a priority granting unit to grant priority to one or more indoor units; and
an auto changeover unit to determine whether the one or more indoor units granted with priorities are operating and granting control right for auto changeover to at least one operating indoor unit with priority.

2. The multi air conditioner as claimed in claim 1, wherein the auto changeover unit grants the control right for the auto changeover only to the indoor unit with highest priority among the indoor units with priorities.

3. The multi air conditioner as claimed in claim 1, wherein when the indoor unit granted with control right is turned-off and there are no other operating indoor units with priorities, the auto changeover unit maintains an operation mode of the indoor unit granted with the control right that was turned-off.

4. The multi air conditioner as claimed in claim 3, wherein when all the operating indoor units request the same auto changeover, the auto changeover unit performs the auto changeover in response to the request.

5. The multi air conditioner as claimed in claim 1, wherein the auto changeover unit grants the control right for the auto changeover to a first operating indoor unit, wherein the first operating indoor unit is not granted with priority.

6. The multi air conditioner as claimed in claim 5, wherein the auto changeover unit maintains the control right to the first operating indoor unit even though subsequently, an the indoor unit with priority is operating.

7. The multi air conditioner as claimed in claim 6, wherein when all other operating indoor units request the same auto changeover, the auto changeover unit performs the auto changeover in response to the request.

8. The multi air conditioner as claimed in claim 1, wherein the priority granting unit comprises:
a priority input judging unit judging whether a priority input mode is set; and
if the priority input mode is set, then a priority selecting unit selectively granting priority to one or more indoor units by input of a user.

9. An auto changeover method comprising:
selectively granting priority to one or more indoor units among a plurality of indoor units;
determining whether there is one or more indoor units with priorities among the operating indoor units; and
granting control right for auto changeover to at least one indoor unit with priority.

10. The method as claimed in claim 9, wherein the step of granting the control right grants the control right for the auto changeover to the indoor unit with highest priority among the indoor units with priorities.

11. The method as claimed in claim 9, further comprises granting control right for auto changeover to a first operating indoor unit, wherein the first operating indoor unit is not granted with priority.

12. The method as claimed in claim 10, further comprises maintaining an operation mode of the indoor unit granted with control right when the indoor unit granted with control right is turned-off and there are no other operating indoor units with priorities.

13. The method as claimed in claim 11, further comprises maintaining an operation mode of the indoor unit granted with control right when the indoor unit granted with control right is turned-off.

14. The method as claimed in claim 12, further comprises performing the auto changeover in response to a request when all the operating indoor units request the same auto changeover.

15. The method as claimed in claim 13, further comprises performing the auto changeover in response to a request when all the operating indoor units request the same auto changeover.

16. A multi air conditioner comprising:
a control granting unit that grants control right for changeover to one indoor unit based on whether the indoor unit was first to operate when the multi air conditioner begin to operate; and
an auto changeover unit to determine whether the indoor unit with the control right is requesting a changeover and performing the changeover according to the request.

17. The multi air conditioner as claimed in claim 16, wherein the control granting unit does not transfer control right to another indoor unit and the auto changeover unit maintains an operation mode of the indoor unit granted with control right when the indoor unit granted with control right is turned-off.

18. An auto changeover method comprising:
determining whether there is an indoor unit that is first to operate;
granting control right for changeover to the indoor unit that is first to operate;
determining whether the indoor unit with the control right is requesting a changeover; and
performing the changeover according to the request.

19. The auto changeover method as in claim 18, further comprises maintaining an operation mode of the indoor unit granted with control right when the indoor unit granted with control right is turned-off.

20. The auto changeover method as in claim 19, further comprises performing the auto changeover in response to a request when all other operating indoor units request the same auto changeover.
